(19) United States
(12) Patent Application Publication
(10) Pub. No.: US 2009/0157563 A1
(43) Pub. Date: Jun. 18, 2009

(54) SYSTEMS, METHODS AND COMPUTER PROGRAM PRODUCTS FOR CREATING A TURNOVER EFFICIENT FRONTIER FOR AN INVESTMENT PORTFOLIO

(75) Inventors: Vitaly Serbin, Boston, MA (US); Peter M. Bull, Boston, MA (US); Haoyuan Zhu, Boston, MA (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 12/180,129

(22) Filed: Jul. 25, 2008

Related U.S. Application Data
(60) Provisional application No. 60/935,064, filed on Jul. 25, 2007.

(51) Int. Cl. G06Q 40/00

(52) U.S. Cl. 705/36 R

(57) ABSTRACT

A method, system and computer program product for optimizing return of an investment fund, based on a correlation between AUM and turnover, include steps of generating a turnover efficient frontier for an investment fund that models fund return versus fund turnover for one or more fund sizes; determining a current fund return and fund turnover of the fund; determined a current position of the fund on the turnover efficient frontier based on the current fund return and fund turnover; and determining whether an increase or a decrease in one of fund size or turnover will move the fund to an optimal point on the turnover efficient frontier.

### CROSS-REFERENCE TO RELATED APPLICATIONS

Pursuant to 35 U.S.C. § 119(e), this application claims benefit of priority to U.S. Provisional Patent Application No. 60/935,064, which was filed on Jul. 25, 2007, the entire contents of which are incorporated herein by reference.

### BACKGROUND OF THE INVENTION

1. Field of the Invention

The present invention relates generally to systems and methods for managing and analyzing portfolios. More particularly, the present invention relates to systems and methods for creating a turnover efficient frontier.

2. Description of the Related Art

There has been significant growth of the US mutual fund industry in recent years. Some estimates state that over $10 trillion were under management by October 2006. Understanding the sources of fund performance has never been more critical than now for investors, regulators, and investment managers.

Beyond growth in assets, capacity becomes an increasingly important issue as traditionally passive products, such as Exchange Trade Funds (ETFs), become structured on higher turnover rules or indices that no longer imply passive trading. Such developments coincide with the ever-increasing mobility of investor capital through global markets in pursuit of higher returns. As the term implies, “excess liquidity” is in excess of the capacity of available strategies to provide risk-adjusted returns above a certain threshold.

The effect of the amount of assets under management (AUM) on fund performance has been the focus of both academicians and practitioners. Most authors document the inverse relationship between the fund's size and its net return. The dominant explanation in the literature attributes diminishing returns to size to rising transaction/turnover costs. For example, Chen, Huang, Hong and Kubik in “Does Fund Size Erode Performance? Liquidity, Organizational Diseconomies and Active Money Management,” American Economic Review, vol. 94, [2004], pp. 1276-1302 (the entire contents of which are incorporated herein by reference), show that fund excess returns decrease in the amount of capital employed.

Although higher turnover is often necessary to utilize the informational advantages a superior manager might have, articles such as those by Wermers, “Mutual fund performance: An empirical decomposition into stockpicking talent, style, transactions costs and expenses”, Journal of Finance, vol. 55(4), [2000], pp. 1655-1695; Perold and Salomon, “The Right Amount of Assets Under Management.” Financial Analysts Journal, vol. 47(3) [1991], pp. 31-39; and Vangelisti, “The Capacity of an Equity Strategy.” Journal of Portfolio Management, vol. 32(2) [2006], pp. 44-50, (the entire contents of each of these references are incorporated herein by reference) for example, show that performance deteriorates as fund managers have to turn over larger volumes of stock, incurring explicit (commission) and implicit (market impact, front-running, etc.) transaction costs.

In another example, described in Kahn and Shaffer, “The Surprisingly Small Impact of Asset Growth on Expected Alpha,” Journal of Portfolio Management, vol. 32(1) [2005], pp. 49-60 (the entire contents of which are incorporated herein by reference), a framework is used where increasing AUM requires a decrease in turnover and is accompanied by declining alpha (both gross and net), leading to the conclusion that net alpha is not very sensitive to increases in capacity provided that good care is taken to control turnover.

If competitors follow similar investment strategies, then stocks with high next-month alpha might become more expensive to trade. If many investors buy or sell a limited universe of “hot” stocks, then it might not be sufficient to spread out trades over more stocks, as Kahn and Shaffer suggest. Besides the limited potential for reducing costs, investing in more stocks might result in deterioration of the gross alpha. In addition, many investment strategies, such as merger or index arbitrage, do not lend themselves to expanding the investable universe (Coval and Stafford. “Asset Fire Sales (and Purchases) in Equity Markets.” Harvard Business School Working Paper, No. 05-077[2005], the entire contents of which are incorporated herein by reference).

Thus, there is a need for new and improved systems and methods for analyzing and optimizing investment portfolios.

### SUMMARY OF THE INVENTION

Further applications and advantages of various embodiments of the present invention are discussed below with reference to the drawing figures.

According to aspects of the present invention, a computer implemented method is provided that determines a relationship between the turnover, fund strategy and assets under management (AUM) of an investment fund, calculates an optimal point between turnover and AUM that maximizes net annual return. According to embodiments of the present invention, further steps are provided for developing recommendations for changes to an investment fund to reach optimal points balancing turnover and AUM.

According to aspects of the present invention, a system is provided for determining the optimal amount of turnover an investment fund can tolerate before net return begins to decrease by generating a turnover efficient frontier from historical trade data for the fund, and identifying a current position of the fund on the turnover efficient frontier. The current position can be identified by, for example, calculating actual returns from portfolio trading data.

According to aspects of the present invention, a system including a client interface coupled with an electronic data network is provided. The client interface can include portfolio management tools and can access portfolio data relating to assets in a portfolio to be managed. The data can include information about each asset in the portfolio, such as symbol, size, current value, what percentage of the total value of the portfolio each asset comprises. The data can be stored either by the client or on a provided server as part of the electronic data network. The portfolio management tool can develop a turnover efficient frontier based on the portfolio data, and project the optimal balance between turnover and AUM for a fund in the portfolio.

According to an embodiment of the present invention, market impact costs are quantified on an individual stock level, thus providing enough granularity as for their source. Combining stock-specific estimates of the trading costs with stock-specific alphas allows for a more realistic way of analyzing optimal capacity relative to doing it at the fund level.

### BRIEF DESCRIPTION OF THE DRAWINGS

FIG. 1 is a block diagram of a system for reasonably simulating the residual return of an individual stock or alternatively for reasonably simulating the residual return and optimal turnover of an investment fund according to an embodiment of the present invention.

FIG. 2 is a flow diagram illustrating an exemplary method for reasonably simulating the residual return of individual stocks in an investment portfolio, and in aggregate simulating the residual return of the portfolio, for an upcoming time period according to an embodiment of the present invention.

FIG. 3 is a box plot showing simulated values for forecasted alpha, plotting a fund manager's forecasting ability (IC) versus a correlation coefficient between forecasted alphas and actual stock returns.

FIG. 4 is a graph simulating the average market impact of trading $10M in Russell 3000 stocks on a monthly basis during 2005, plotting the average market impact of randomly selected stocks within the highest, lowest and middle investment return deciles.

FIG. 5 is a flow diagram generally illustrating the procedure for selecting and rebalancing the fund portfolio used in jointly modeling forecasted alpha and liquidity.

FIG. 6 is a graph showing optimal turnover rates for different levels of AUM. The simulation reflected in FIG. 6 illustrates that transaction costs of turnover can project the optimal amount of turnover for a fund of a given monetary size.

FIG. 7 is a graph detailing FIG. 6, showing there is an “efficient frontier” of turnover that follows the optimal turnover points for funds of a given volume of AUM.

FIG. 8 is a graph modeling the amount of value added to a find of a given AUM, contrasting the optimal turnover versus a baseline strategy of 60% fund turnover during equal time periods.

FIG. 9 is a flow diagram illustrating a method to optimize the capacity and rebalancing strategy of an investment fund in relation to the calculated turnover efficient frontier according to an embodiment of the present invention.

### DETAILED DESCRIPTION OF THE PREFERRED EMBODIMENTS

While the present invention may be embodied in many different forms, a number of illustrative embodiments are described herein, with the understanding that the present disclosure is considered as providing examples of the invention, and such examples are not intended to limit the invention to any specific preferred embodiment described and/or illustrated herein.

It will be readily understood that the present invention, as described below, includes systems, processes, and components that may be implemented using one or more general purpose computers, microprocessors, or the like programmed according to the teachings of the present specification, as will be appreciated by those skilled in the relevant art(s). Appropriate software may be available that may be customized or used off-the-shelf to perform one or more aspects of the present invention. Further, aspects of the present invention can be implemented with one or more computer program modules developed by skilled programmers in readily available computer languages such as C++, PHP, HTML, XML, etc., based on the teachings of the present disclosure, as will be apparent to those skilled in the relevant art(s).

Similarly, one skilled in the art will understand that the present invention may be embodied in numerous configurations, including different computer architectures, such as centralized or distributed architectures and should not be limited to the exemplary architecture(s) disclosed herein. Moreover, one or more aspects of the present invention may include a computer-based product, which may be hosted on a storage medium and include executable code for performing one or more steps of the invention. Such storage mediums can include, but are not limited to, computer disks including floppy or optical disks or diskettes, CDROMs, magneto-optical disks, ROMs, RAMs, EPROMs, EEPROMs, flash memory, magnetic or optical cards, or any type of media suitable for storing electronic instructions, either locally or remotely.

One problem the invention seeks to address is understanding the source of investment fund performance. In order to understand investment fund performance, one must also determine how the overall capacity and liquidity of a market, or a segment of the market, affects the funds that invest in that market. The inventors of the present invention have determined that one can accurately predict investment fund performance by modeling alpha (α), fund strategy and the liquidity of the stocks in an investment fund. Preferably, historical trade data for a fund is used to calculate alpha (α) for an investment portfolio over a selected period of time.

If historical data is unavailable, a method is provided to simulate the alpha for an upcoming duration of investing or time horizon. According to an aspect of the present invention, a method to simulate alpha for individual stocks is provided, which can be then used in the model.

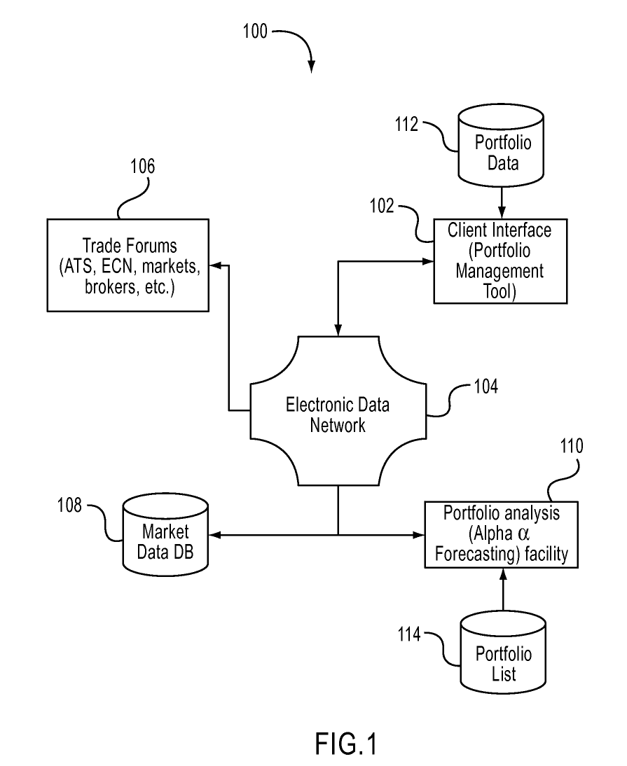

FIG. 1 is block diagram of a financial management system that includes facilities for creating a turnover efficient frontier and for optimizing an investment portfolio. The system may include a client interface 102 that is coupled with an electronic data network 104, with connectivity therethrough to electronic trade venues 106 (e.g., ECN's, markets, ATS's, etc.), real-time and historical market data facilities 108, and portfolio analysis facilities 110.

Client interface 102 may include portfolio management and trading facilities and be coupled with data storage facilities 112 (e.g., remote or local databases, file management systems, or other memory components) configured to manage data for a portfolio of tradable assets (e.g., equities) and other investment and trade data, and to generate and submit orders to buy and sell tradable assets. For example, client interface 102 may include computer processing components executing one or more of a portfolio management application, order management system (OMS), or an execution management system. Client interface 102 may further be configured to execute a web browser or other application for accessing remote applications over the electronic data network 104. Optionally, the portfolio analysis facilities 110 may be coupled with data storage facilities 114 that are configured to manage portfolio data for multiple clients.

As will be explained in further detail below, the system may be configured to calculate and display net return (or net alpha) for each tradable asset in a portfolio and to model return with liquidity to create a turnover efficient frontier, from which a portfolio can be optimized. Accordingly, one will understand that the processes described below can be implemented within the framework of system 100 via combination or hardware, software and/or firmware.

A few key assumptions are made herein. First, the nominal return, or “paper return,” of a given strategy is assumed to be known or satisfactorily estimated a priori. Second, the trading volume in investable assets is assumed to increase proportionately with the amount of AUM so that the turnover rate is held constant while the strategy is being implemented. Other strategy inputs such as the commission rate are also held constant.

Under this framework, the performance drag accompanying higher AUM can be attributed solely to increased marginal market-impact costs. The methods of the current invention can be executed with the perspective that a forecast of market-impact cost of a volume-weighted average price (VWAP) strategy is used in this case, rather than one tailored to more elaborate trading styles or venues, as it represents average liquidity demand by definition. As a building block for capacity analysis, daily market-impact cost estimates can be extrapolated, adjusted for leverage, cash drag, etc., to complete the net expected return calculation for individual funds.

Technically, a VWAP of a stock over a period of time is the volume-weighted average price paid per share during that period by all market participants. VWAP strategies are defined as buying and selling a fixed number of shares at an average price that is as close to VWAP as possible. In practice this amounts to matching the volume pattern of the underlying stock over a specified time horizon (typically one day). Therefore, a trader who follows a VWAP strategy will trade more during periods when the market volume is high and less during periods when the market volume is low. For further discussion of VWAP strategies, see, for instance, Madhavan, VWAP Strategies, Investment Guides, Spring [2002], pp. 32-39 (the entire contents of which are incorporated herein by reference).

Capacity should be defined only in terms of the capacity of an investment strategy. Acknowledging this leads to the realization that portfolio managers themselves will not always know the optimal capacity of their strategy. For example, the capacity of convertible arbitrage strategies might vary depending on the supply of convertible bonds.

The present invention includes steps for quantifying the dependency between market-impact costs and overall portfolio liquidity, showing that liquidity could be affected by changing the breadth of the portfolio or by changing its investable universe, and highlighting the varied market-impact consequences of trading different lists with different turnover levels. The present invention is based upon the concept that liquidity alone cannot explain the notion of the optimal operating capacity of a fund—it must be combined with expected return, or alpha (α). Further aspects of the present invention will be readily apparent from the following example.

The present invention uses a bottom-up approach to measuring costs and α, as opposed to Kahn and Shaffer which used a top-down approach. More specifically, an embodiment of the present invention simulates the next-month alpha for each stock and use a stock-specific estimate of market impact cost for the same month. This approach relaxes two crucial assumptions made by Kahn and Shaffer. First, the present invention does not assume that alpha and liquidity are independent. Accounting for the possibility that alpha and liquidity might be related is more consistent with the evidence that high-alpha (e.g. high-momentum) stocks might be less liquid, and thus, more expensive to trade. Second, the use of market impact curves for the same period during which alpha is measured relaxes the assumption that trading costs are independent of the investment strategy.

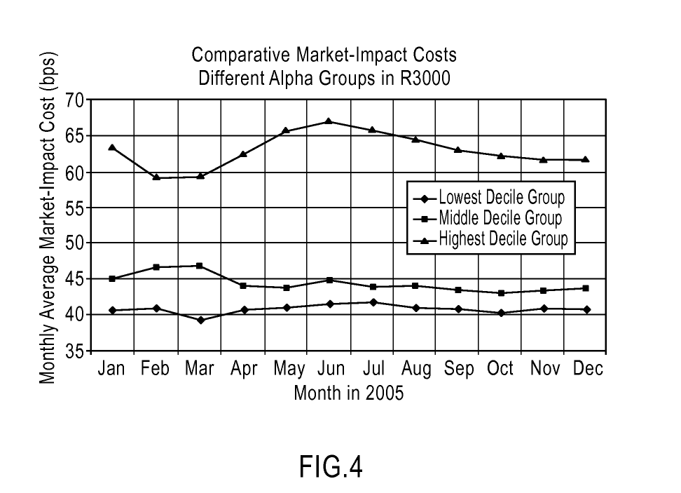

Another dimension along which actual trading costs may differ is return/alpha. There is compelling evidence in the literature that momentum strategies rely on relatively illiquid stocks, and that actual returns might differ substantially from the paper returns. The article by Sadka, “Momentum and post-earnings-announcement drift anomalies: The role of liquidity risk.” Journal of Financial Economics, vol. 80(2) [2006], pp. 309-349 (the entire contents of which are incorporated herein by reference), demonstrates that high-momentum portfolios load positively on the liquidity factor, while low-momentum portfolios load negatively on the same factor. The present invention extends the evidence by plotting the average market impact costs of trading $10 million in stocks that are Russell 3000 constituents. The R3000 list is separated into ten deciles, according to the realized absolute returns in each month of 2005 and then 100 stocks are randomly picked within each decile. FIG. 4 depicts average market impact cost for each absolute return decile.

FIG. 4 illustrates that (1) the stocks with the more extreme returns are also the most expensive to trade and (2) that market-impact costs vary with time, thus implying a systemic connection to liquidity. Mean absolute return is 0.46% for lowest decile and 22.4% for highest decile. However, corresponding mean returns are mere 0.01% and 0.5% (all numbers are monthly).

The evidence has two implications for studies on the relation between investment strategies and trading costs and for studies on fund capacity, in particular. First, alphas and costs are related. The most extreme returns decile is also the most expensive to trade. Second, average market impact costs are time-varying which points out to systematic liquidity effects. Note that both results are obtained with no assumptions on cost- and return-generating mechanism. Having stock-specific returns and trading costs allows us to “let the data speak for itself”. This evidence should not be viewed as an attempt to incorporate trading costs into momentum strategy. This observation points out that anyone who runs any investment strategy should be prepared to pay higher than expected costs due to liquidity shortage in stocks that are being massively bought or sold. The present invention uses absolute returns which serve as a good proxy for these types of events.

This evidence further offers conclusions similar to those of Chan, Getmansky, Haas, and Lo in “Systemic Risk and Hedge Funds.” MIT Sloan Research Paper No. 4535-05, available at SSRN: http://ssrn.com/abstract=671443, [2006], the entire contents of which are incorporated herein by reference. Those authors use autocorrelations in hedge fund returns as opposed to actual transaction costs to proxy for illiquidity, but in the end they also report “considerable swings” in illiquidity over time. Whether our results are related to momentum or to some other statistical arbitrage strategy is not important. Our main point is more general: anyone who runs an investment strategy should be prepared to pay higher than expected costs due to liquidity shortages in stocks that are massively bought or sold (absolute returns are a good proxy for such events). The substantial losses some quant funds suffered in August 2007 seem to corroborate this conjecture. The concept of systematic liquidity has recently attracted a lot of interest. Interested readers might look at Chollete et al., “What Captures Liquidity Risk? Order Based Versus Trade Based Liquidity Measures” [2007], available at SSRN: http://ssrn.com/abstract=967598; Domowitz et al., “Liquidity Commonality and Return Co-movement,” Journal of Financial Markets, vol. 8 (4) [2005], pp. 351-376; and Kamara et al., “The Divergence of Liquidity Commonality in the Cross-Section of Stocks” [2007], available at SSRN: http://ssrn.com/abstract=943040; the entire contents of each of these references are incorporated herein by reference.

The following assumptions about the portfolio formation and rebalancing process in the simulations herein: (1) IC is fixed for the whole period; (2) the rebalancing frequency is fixed at one month; and (3) the investable universe is the S&P 500. The first two assumptions are innocuous insofar as relaxing them would complicate modeling without shedding additional light on the main focus of the present invention. Relaxing the third assumption, however, could provide an opportunity for further research along similar lines. It is anticipated that using less liquid, small capitalization stocks from the Russell 2000 would result in lower optimal turnover rates for given AUM and IC levels, but focusing more explicitly on liquidity groups versus capitalization groups that typically define the major indices could provide additional insight. This, of course, fits within the more general effort of refining stock selection procedures either to increase the optimal turnover level per level of AUM (along with higher returns) or to increase a fund's threshold capacity for a given level of return.

The dependence between an equity strategy's net return and its size is studied using stock-specific market impact costs and alphas. The benefits of using a bottom-up approach of calculating fund's trading costs are demonstrated by linking contemporaneous market-impact costs and absolute returns. A typical circumstance in which liquidity becomes particularly important is in changing the breadth of a portfolio or in portfolio transitioning. By extension, having leeway with respect to the investment universe (e.g. Europe vs. Asia) should prove beneficial when it is feasible. Conversely, the effort to increase assets while pursuing smaller tracking error could be frustrating, especially when suitable derivative products are not available. Looking for common factors that allow for more systematic approaches to determining capacity limits across all funds and asset classes is a promising area for future research. This research can enhance the development of new structured products and/or institutional mandates.

The industry is primed for this type of approach since the existing literature has assumed highly simplified mechanisms for transaction costs. For example, Bogle in “Bogle on Mutual Funds: New Perspectives for the Intelligent Investor,” McGraw-Hill, [1994] (the entire contents of which are incorporated herein by reference), multiplies the fund's turnover rate by 2 and then by 0.6 percent to estimate the lower bound of the microstructure drag-down on performance. The paper by Vangelisti [2006] investigates fund capacity from a transaction cost perspective; however, the underlying model for transaction costs remains a simple linear function of MDV, which is more specifically calculated as a stock's 21-day median daily dollar volume.

A further embodiment of the present invention recognizes that alphas, trading costs and turnover are related but allow for a reasonable degree of separation between their effects. Consequently the calculations of the present invention are not investment strategy-dependent, thus avoiding a common pitfall of some of the existing studies. For example, the analysis in Vangelisti [2006] revolves around proprietary investment strategy, which is never disclosed. The main problem with putting portfolio-construction mechanism into a black box is that alphas, AUM and turnover become impossible to separate. On the other hand, an earlier study assumes transaction costs to be independent of alpha (see Perold and Salomon [1991], Table II), and does not explore the relation between alpha and turnover.

According to embodiments of the present invention, an alpha-generating process is provided that is transparent and strategy-independent. Any strategy with a given information coefficient IC (see Grinold, “The Fundamental Law of Active Management.” Journal of Portfolio Management, vol. 15(3) [1989], pp. 30-37) (the entire contents of which are incorporated herein by reference) will produce the same set of alphas. The present invention also implements a simple way of making alphas time- (and therefore, turnover-) sensitive. Finally, the present invention allows for the possibility that stocks with higher alpha are indeed more expensive to trade. As a result, the capacity problem can be formulated as an optimization problem, in which the users have to accept a trade-off between higher AUM and lower net alpha subject to the monthly turnover constraint.

Formalizing the above discussion leads to a simple variation of the classical Markowitz optimization problem:

$${max}_{{w}_{t , AUM}} {ω}_{t}^{′} μ * AUM - τ * f ( AUM , {ω}_{t} , {ω}_{t - 1}^{*} ) \\ s . t . \\ {ω}_{t}^{′} \sum {ω}_{t} \leq {σ}_{0}^{2} \\ A {ω}_{t} = b \\ C {ω}_{t} \geq d \qquad Eq . ( 2 )$$

where μ is the vector of expected returns, τ is the coefficient of aversion to transaction cost losses, Σ is the n×n symmetric covariance matrix of asset returns, f is the price impact function, and AUM is the amount of assets under management. The vector of weights ωₜ contains n decision variables, while the vector of optimal weights at the end of previous period is denoted ωₜ₋₁*. An upper limit on the portfolio variance is denoted by σ₀². An m×n matrix A and an m×1 vector b stand for possible linear equality constraints and p×n matrix C together with p×1 vector d to stand for possible linear inequality constraints.

While in the classical Markowitz formulation the optimization is over the vector of decision variables ωₜ, the problem Eq. (2) adds AUM to the decision set. The objective function can be reformulated, so that in Eq. (2) one maximizes expected value-added instead of portfolio return, which is consistent with the above.

The portfolio of an investment fund will be comprised of stocks within the defined investable universe. In practice, both nominal alpha forecasts and market-impact estimates can be incorporated by using an optimizer that properly scales both terms simultaneously in the objective function. Several commercial portfolio optimizers (e.g., BARRA, ITG Opt®) include the penalty on the expected transaction cost into the objective function. Since the transaction costs that appear in the optimization problem are only estimates, having a well-specified market-impact cost function is crucial.

One goal of the present invention is to simulate reasonable forecast of next month's alpha. The examples herein assume that a money manager will be performing this task every month; although in reality the forecasting horizon might range from several hours to several years. It is further assumed that the precision with which forecasted alpha will be close to realized (and observed) return r is directly proportional to manager's forecasting ability IC and inversely proportional to stock's volatility σ.

Suppose that r and α follow a bivariate normal distribution, i.e.

$$α = ( \begin{matrix}r \\ α\end{matrix} ) \sim N ( ( \begin{matrix}0 \\ 0\end{matrix} ) , ( \begin{matrix}{σ}^{2} , & IC * {σ}^{2} \\ IC * {σ}^{2} , & {σ}^{2}\end{matrix} ) ) .$$

Using the conditional distribution of bivariate normal distribution, the following is obtained:

(α|r= r̅)˜N(IC* r̅,σ²*(1−IC²)).

This is equivalent to

α=IC*rᵢ+σ*ε*\sqrt{1−IC²} with ε˜N(0,1) Eq. (1).

Equation (1) provides the basis for simulations performed by the present invention.

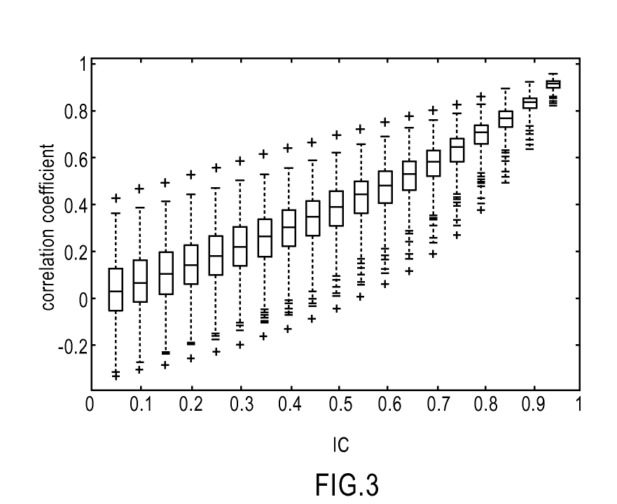

FIG. 3 is a box plot that shows the correlation coefficient between the simulated alphas and the actual return of stocks (shown as normal distributions) versus the IC. FIG. 3 illustrates that with increased IC, i.e. with a better or more knowledgeable fund manager, the correlation between simulated and actual returns becomes closer.

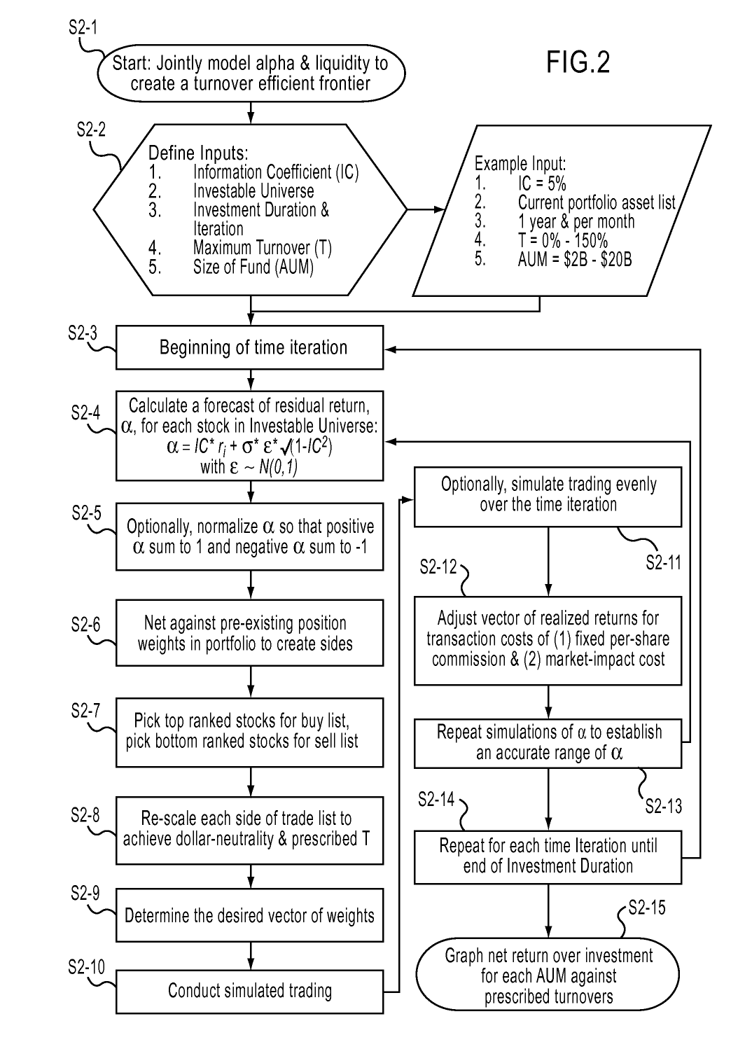

FIG. 2 is a flow chart illustrating an exemplary method for jointly modeling return (or alpha) and liquidity of an investment fund according to embodiments of the present invention, i.e. determining the turnover efficient frontier for a given investment fund/portfolio. Processing begins at Step S2-1 and immediately proceeds to Step S2-2.

At Step S2-2, a number of inputs are defined which include, preferably, an information coefficient (IC), an investable universe definition, the duration of the investment and iterations that the overall duration is divided into, the maximum turnover (T), and the size (i.e. assets under management) of the fund (AUM). As already explained above, these inputs can be input via an appropriate client interface and can be stored in memory facilities. Further, these inputs can be derived from historical trade data. For example, a user could provide a fund definition along with 1 years worth of trade data for the fund.

The method to jointly model alpha and liquidity initially requires that these parameters be defined for the following reasons. A value for IC must be defined for use in forecasting alpha. In practice, the IC for a specific fund manager can be determined as a correlation coefficient between the historical performance of the fund manager in creating returns relative to a pertinent index fund baseline. The “investable universe” chosen is the scope of the market that will be invested in, i.e. the assets in the portfolio. Examples herein illustrate that simulations limited to certain segments of the market, such as the S&P 500 or the Russell 3000, reflect the differences in stocks with different cap sizes, and thus different capacity and liquidity. The duration of the investment as well as the length of time iterations between rebalancing the fund portfolio must be defined to start and end points for the simulation. The monetary size of the fund in application will be related to the actual size of the assets under management by a fund manager. Finally, as a goal of the invention is to determine the optimal amount of turnover for a given fund, i.e. the percentage of turnover for a given fund that results in the greatest net return on investment, the range of acceptable turnover must be defined. While examples herein use a range of monthly turnover ranging from 0% to 150% of the value of the assets, in practice a narrower range of turnover might be imposed on a fund for external reasons.

In one example, using a hypothetical long-short portfolio manager, IC can be set to 5%, the investable universe can be set to the S&P 500, the duration can be set to 1 year, maximum turnover T can be set to a range from 0 to 150%, and the size of the fund (i.e. the AUM) can be arranged between $2 billion and $20 billion US.

Step S2-3 represents the beginning of each chosen iteration of time during the investment, which immediately proceeds to Step S2-4. In the example using the S&P 500, the time iterations are each month over the course of the year. At Step S2-4, the simulated residual return, herein labeled α, for each stock in the chosen scope of investable stocks is simulated by the formula of equation (1): α=IC*rᵢ+σ*ε*√(1−IC²) with ε˜N(0,1). In the equation, σ is volatility (determined by the ITG U.S. Risk Models), r is the realized return (where rᵢ is the initial r the simulations start with), and IC is the aforementioned knowledge/skill of the fund manager. The normal distribution represented by ε selects a value between the range of 0 and 1 based on the probability of where that value falls in a normal distribution. Because E is not a constant value for each forecast of α, the simulation forecasts a for each chosen set of the parameters a sufficient number of times (i.e. uses a Monte-Carlo method) to determine an average and range for the overall simulated residual return.

In a preferred embodiment of the invention, at Step S2-5, each α is optionally normalized so that the positive α values will sum to 1 and the negative α values will sum to −1. At Step S2-6, preexisting position weights for each stock are compared with the simulated residual returns, or normalized forecasted α values, to estimate the net change and return for each individual stock in the portfolio. The weight of a position is effectively the percentage of the fund invested in a particular asset. The results of the forecasted a netted against the position weights are used to create sides (i.e. buy and sell rankings) for the fund portfolio. The sides are preferably created to reflect the projected amount of return of an asset based upon the forecasted α and weight of the asset position in the portfolio.

Next at Step S2-7, the top ranked stocks are picked for the buy list while the bottom ranked stocks are picked for the sell list for hypothetic trading used to simulate turn over. In one example, where the S&P 500 is the chosen investable universe, the 200 stocks with the top ranked α values comprise the buy list, and the 200 stocks with the bottom-ranked α values comprise the sell list.

Next at Step S2-8, each size of the trade list is rescaled to achieve dollar-neutrality and the prescribed turnover (T). Dollar-neutrality implies that the purchase price of the buy list equals the sale price of the sell list. The prescribed turnover limits what monetary percentage of the fund can be traded; this value is varied within the defined range for the simulation.

Next, at Step S2-9, the desired vectors of the weights are determined. This determination of weights calculates the desired amount of investment in each asset for the next time period.

Next at Step S2-10, the simulated trades are conducted. In a preferred embodiment of the invention at Step S2-11, the simulation can optionally be conducted evenly over the preselected time iteration. In an example of this preferred embodiment, the simulation is conducted evenly over twenty-one trading days during the course of a month. In a further preferred embodiment of the invention a VWAP strategy is used each day for the simulation. The result of such a trading strategy, is that the return for month is evenly divided between the legacy and target portfolio.

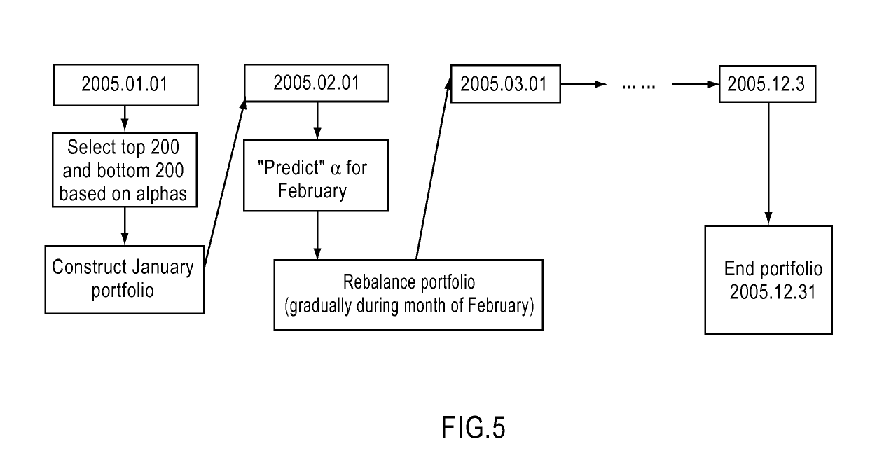

Market-impact cost can derived from ITG's ACE® Cost Curves data assuming the daily VWAP trading strategy described above. Estimates of costs in the examples herein are calculated using version 2.2 of the ITG Agency Cost Estimator (ACE) model. ITG ACE is a mathematical model that provides a pre-trade forecast of the price impact cost of an order. ITG ACE® Cost Curves data contains expected ACE model forecasts of implementation shortfall cost along with the standard deviation of the cost for varying order sizes. A graphical example of the procedure is depicted in FIG. 5. Features of ITG ACE are described in U.S. Ser. No. 10/166,719, entitled SYSTEM AND METHOD FOR ESTIMATING AND OPTIMIZING TRANSACTION COSTS, filed on Jun. 12, 2002, the entire contents of which are incorporated herein by reference. (See, also, www.itg.com.) ACE measure of execution costs includes both the bid-ask spread and the price impact of the trade. Explicit cost components (e.g. commissions) can be easily added to the ACE estimate to obtain a total cost of trading. The input variables for this model include the relative order size (number of shares in proportion to MDV), time-weighted five-day average spread and forward-looking daily volatility for each stock. The cost curves are also conditioned on individual stocks' liquidity level, split- and dividend-adjusted close-to-close returns, intraday volume profile, as well as the trading intensity of specific orders.

ACE Cost Curves, while being a commercial product, rely on transparent methodology described in ITG white paper (ITG Inc., ITG ACE—Agency Cost Estimator (2007), available at http://www.itq.com/news_events/papers/ACE_White_Paper_{—}200705.pdf, the entire contents of which are incorporated herein by reference). Using a different price impact model would lead to the same qualitative conclusions, as long as the model recognizes the concave relationship between unit costs and volume and correctly accounts for different liquidity, volatility, order urgency, and spread dynamics. In addition, the parameters in a good price impact model should be calibrated in order to match empirical trading costs. The ACE model used in the paper was calibrated using 2004-2005 execution data from more than 80 large institutional clients. Making transaction costs analysis stock-specific allows us to explore the relationship between AUM and alpha across different segments of stocks and potentially—across different markets.

Many active managers are interested in the specific levels of median daily volume (MDV) traded in addition to turnover since they do not want to trade beyond a certain fraction of MDV for mandated and/or risk-control reasons (e.g., 10% or 20% of MDV). Translating turnover levels into the average percent-MDV traded for the various AUM levels shows that the average percent-MDV traded increases linearly as either turnover or AUM increases, since the present invention employs fixed-breadth trade lists and a one-day VWAP trading strategy. It is found that for most combinations of turnover and AUM studied, the corresponding percent-MDV traded is below 25%, which would be considered a reasonable range for most portfolio managers.

At Step S2-12, the vector realized returns can be adjusted for transaction costs such as (1) explicit fixed per-share commission and (2) implicit market-impact costs. Preferably, a commission is fixed at $0.01 per share and implicit market-impact cost is calculated by the ITG ACE Cost Curves data. The ITG ACE Cost Curves data contains forecasts for implementation shortfall costs as well as a standard deviation for the cost as the trade order size varies. The action of subtracting transaction costs from the predicted return of the fund, establishing the computer realized return, marks the end of a simulation draw, returning a simulated return, or net alpha, over the time iteration for each asset modeled.

At Step S2-13, processing of Steps S2-4-S2-12, computing the realized net return α, for each asset is repeated a sufficient number of times for each value that is varied, such as turnover level or fund size. This is because, as mentioned above, the value for ε varies within the normal distribution between 0 and 1, so an accurate representation of forecasted alpha requires multiple simulations for statistical certainty for the range of a used to predict individual stock and overall fund performance. This results in a range of α and expected returns for the given values of both turnover and AUM. Market-impact costs need not be taken into consideration during scoring and rebalancing. Market-impact cost estimates are preferably computed on the back-end in order to illustrate the consequences of the “blind pursuit” of alpha at different AUM and turnover levels.

As shown at Step S2-14, processing of Steps S2-3-S2-13, the rebalancing of the portfolio, is repeated for each time iteration until the end of the overall investment duration. In the shown exercise, this rebalancing occurred each month over the course of the year, as diagrammed in FIG. 5.

FIG. 5 illustrates the simulation where a selection of stock funds in a fund portfolio is rebalanced monthly, based on the prediction of forecasted alpha, over the course of a year (using the time period of the example). The simulation starts from cash on day 1 and keeps turnover at 100% in each simulation for the month. This allows the simulation to achieve a reasonable steady-state portfolio by the end of the month or period. Market-impact and commission costs from the month can be also dropped so as not to skew the results with the initial transition from cash. Because of the latter, the first month returns of the simulation are ignored when calculating annual returns (i.e., calculations only use steady-state returns, treating month 1 as a burn-in period).

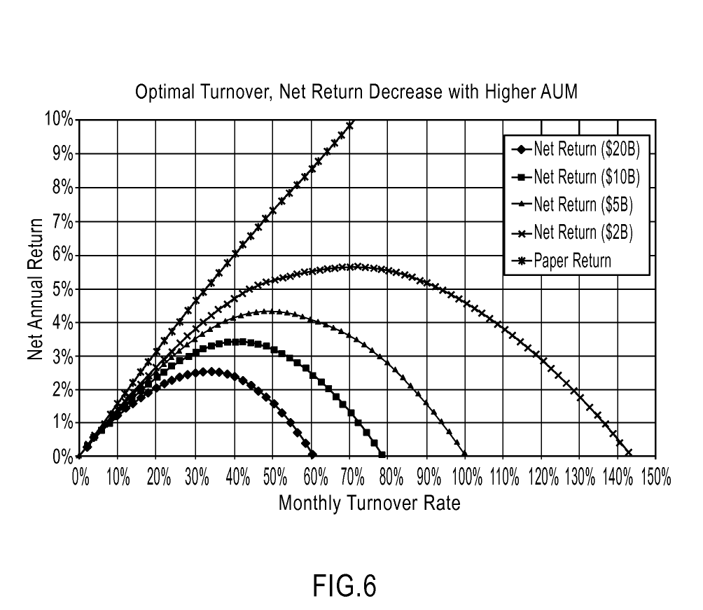

Finally, at Step S2-15, the average net returns of the portfolio, at the chosen AUM values, are plotted against each turnover rate to build the turnover efficient frontier. The results in the above example are graphically illustrated in FIG. 6. This graph, which accounts for capacity due to the size of AUM, and accounts for market-impact costs of turnover and the skill of the fund manager by calculation of α, displays the turnover efficient frontier as the curve which connects the optimal points of the fund at varied AUM levels.

Several important results are apparent from FIG. 6. First, because of transaction costs, the paper return dominates the returns of the portfolios at all AUM and turnover levels except zero. Second, where turnover is relatively low, i.e., below 15%, all four AUM levels show an almost linear increase in net return. Finally, as turnover increases past 20%, net returns for the larger AUM portfolios peak and drop much more quickly. For the $10 billion portfolio, net return maximizes at 3.40% with 40% monthly turnover, while the $20 billion portfolio maximizes at 2.50% net return with 34% monthly turnover. The $2 billion portfolio achieves a net return closer to 6%, and one can assume that even lower AUM levels would continue to approach the paper return (the paper return includes neither fixed commission costs nor market-impact costs).

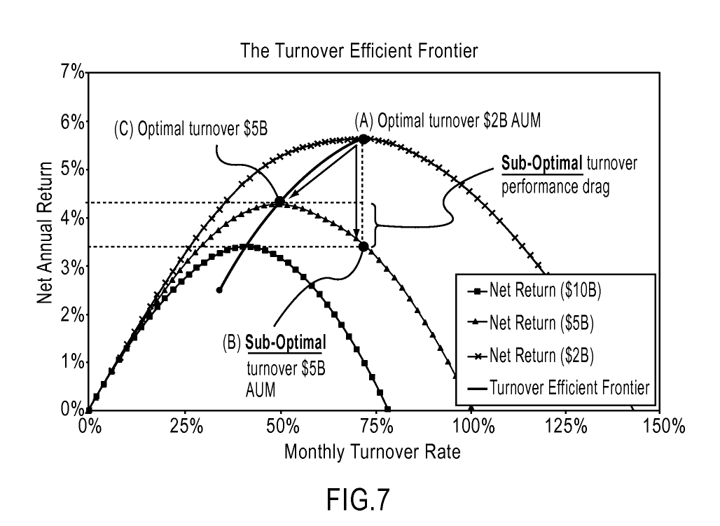

The results of the simulations graphed in FIG. 6 lead to an efficient frontier for turnover (i.e., the “turnover efficient frontier”), which is illustrated in FIG. 7. As shown in FIG. 7, larger volumes of AUM for the S&P 500, which thus take up more capacity of a given market, reach their optimal investment return at a proportionally lower turnover percentage. This turnover efficient frontier can now be used to optimize a portfolio of holdings size or turnover given the portfolio investment strategy.

For example, consider if a simulated manager increases AUM from $2 billion to $5 billion. If the fund manager holds turnover constant, the manager moves from point A straight down to point B. In order to achieve the highest return under this scenario, the manager will have to decrease turnover to move to point C. Thus, point B represents not just an inefficient portfolio but an inefficient strategy that is paying too much in market-impact costs from excessive turnover relative to skill level represented by IC.

This concept of efficient turnover holds not only in cases when AUM is in flux and capacity is under investigation. If at $2 billion the manager started at any point to the left of A, e.g., with mandated monthly turnover of 20%, the manager would have needed to allow higher turnover in order to maximize returns at point A.

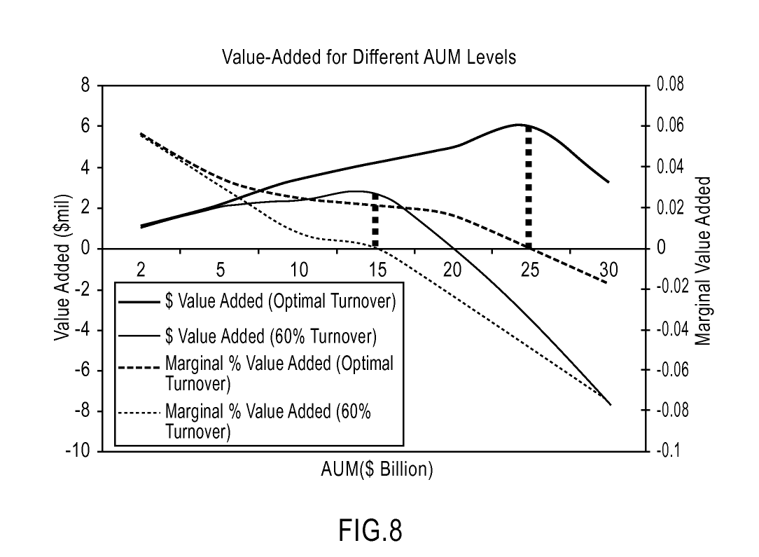

FIG. 8 is a graph of value added against AUM, which is an extension the analysis for FIGS. 6 and 7. The analysis in FIG. 7 is consistent with maximizing the individual fund investor's utility, which happens when a fund's net return reaches its maximum. Alternatively the analysis can be run from the macro perspective, i.e., maximizing the total wealth the fund creates. Naturally, in this case the model shows the amount of value-added instead of net return, as represented in FIG. 8.

FIG. 8 shows the dynamics of the value-added as a function of the start-of-the-period AUM. To show that it pays to choose the turnover level carefully, two scenarios are depicted. First, it is assumed that the fund manager picks optimal turnover at each AUM level, and second value-added is plotted under the assumption that the fund manager keeps the monthly turnover at 60 percent.

Indeed, being able to choose optimal turnover at each level (which corresponds to moving along the efficient frontier of FIG. 7) provides the fund manager with an opportunity to grow the fund to about $25Bn, whereas sticking to 60 percent turnover at each AUM level would result in marginal value-added turning negative at about the $15Bn mark.

Accordingly, one can optimize a portfolio from its turnover efficient frontier by identifying whether to increase or decrease the funds under management and/or by changing the strategy to allow higher or lower turnover, until size and turnover are optimum.

One can generate a turnover efficient frontier for an investment fund by applying the preceding method to a defined portfolio or holdings for the investment fund. That is, the portfolio of holdings will make up the investment universe and a turnover efficient frontier can be produced that is fund specific by performing the described simulations using the investment fund data, such as holdings, trades and returns, as a starting point. The curves of the efficient frontier can be selected based on a given AUM. For example, if a fund being analyzed has a current AUM of $2B, then curves can be provided for AUM's of $1B, $2B, $5B and so forth.

Using the actual return data for the fund being analyzed, one can plot a current position on the turnover efficient frontier for the fund. From this current position, it can be determined whether to increase or decrease either AUM or turnover in order to improve performance and move to an optimal position on the frontier.

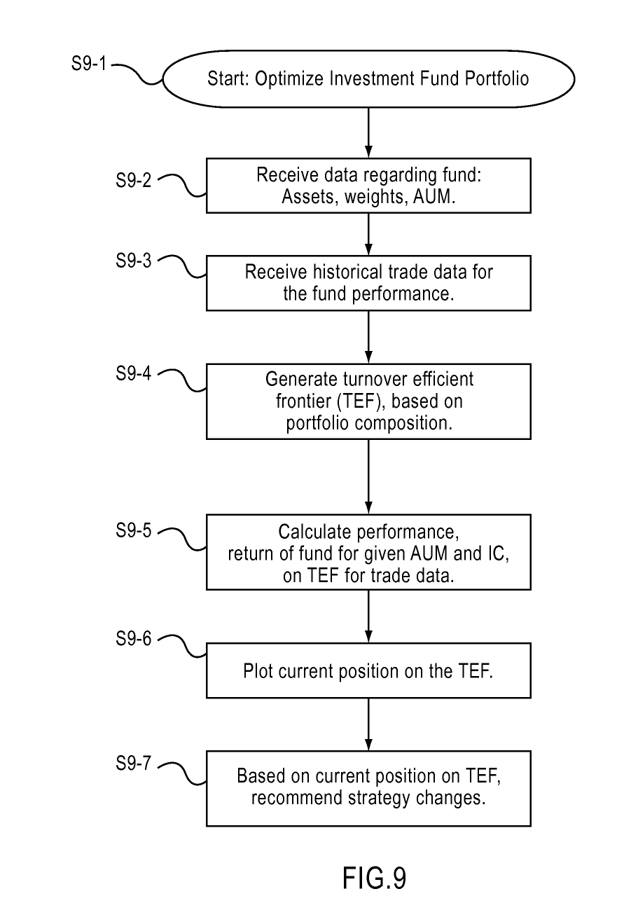

FIG. 9 is a flow diagram illustrating a method to optimize capacity and rebalancing strategy of an investment fund, by determining the turnover efficient frontier for a given fund, comparing portfolio data to the turnover efficient frontier, and adjusting to reach a point of optimal net return for the given investment fund. Processing begins at Step S9-1 and immediately proceeds to Step S9-2.

At Step S9-2, data is received regarding the given investment fund and portfolio including data about the assets in the fund, the weight of assets in the fund, AUM of the fund, turnover requirements of the portfolio, etc. Preferably, trade data is also available.

Portfolio data is used to calculate the turnover efficient frontier for the given investment fund. As already described above, a simulations may be used to generate the curves and certain variables may be estimated or backed out from trade data.

At Step S9-3, historical trade data regarding the fund performance is received. This data can be used to establish an initial point from which to model the turnover efficient frontier, including determining the investment strategy, and also can be used in comparison with the turnover efficient frontier at Step S9-6 (e.g., actual return can be used to identify a current point on the turnover efficient frontier).

At Step S9-4, the turnover efficient frontier is generated. Using the method as described above and as illustrated in FIG. 2, a curve for each prescribed AUM (scaled up or down from the actual AUM of the investment fund) can be plotted for varying percentage of turnover (proportionally from the actual turnover frequency of the investment fund), against values for net return over the duration of the investment.

At Step S9-5, the performance of the given fund is calculated along the turnover efficient frontier for the given AUM and IC based on trade data. Immediately following at Step S9-6, the current position of the fund is plotted in comparison to the turnover efficient frontier.

At Step S9-7, based on the current position of the fund in comparison to the turnover efficient frontier, strategic recommendations are made to optimize the return of the fund. The recommendations may include increasing or decreasing AUM, increasing or decreasing the amount of fund turnover, as well as other similar recommendations.

Analyzing the fundamental law of active management in this context sheds light on an interesting question. So the question arises in the above example of the present invention, where within the constructs of the fundamental law can the increased return resulting from decreased turnover be attributed to moving from point B to point C? In its original form, the law states that the expected net active return E(R_{A}), the active return of an asset above or below the selected benchmark of that asset, can be enhanced by accepting higher active risk, increasing breadth, or improving forecasting ability:

E(R_{A})≈IC·√N·σ_{A}, Eq. (3),

where IC is the information coefficient, or cross-sectional correlation between alphas (simulated active returns) and realized active returns; N is breadth, or the number of independent investment decisions; and σ_{A} is active risk, or tracking error. Clarke, de Silva, and Thorley in “Portfolio Constraints and the Fundamental Law of Active Management.” Financial Analysts Journal, vol. 58(5) (2002), pp. 48-66 (the entire contents of which are incorporated herein by reference), extend Eq. (3) to include the transfer coefficient TC:

E(R_{A})=IC·TC·√N·σ_{A}, Eq. (4)

where TC is the cross-sectional correlation between risk-adjusted alphas and active weights. As Clarke [2002] states, one “can think of the [TC] as an additional adjustment to breadth, N, that reflects the reduction in independent bets because of constraints.” In other words, any portfolio constraints impinging on the full realization of alpha forecasts within the portfolio will cause TC to be less than one.

The fundamental law of active management could be invoked in order to interpret the optimal capacity of the fund. However, in order to do so, one has to re-formulate IC in terms of net (not gross) alpha. If IC is reformulated as the correlation between predicted and realized net alphas, then increasing AUM would be accompanied by decreasing IC (due to transaction costs) and TC (due to imposed constraints on weights aimed at controlling transaction costs), or both. In Table 1 the values of TC and net IC computed for 0% turnover, optimal turnover, and maximum turnover are provided for which net alpha is still non-negative for every level of AUM considered.

TABLE 1
TC and IC for different AUM and turnover levels

| | | | | Max Turnover with non- |
|---|---|---|---|---|
| | | 0% Turnover | Optimal Turnover | negative net alpha |
| $2 B | IC | 0.0276 | 0.0271 | 0.0260 |
| | TC | 0.6442 | 0.7422 | 0.7496 |
| $5 B | IC | 0.0279 | 0.0276 | 0.0256 |
| | TC | 0.6296 | 0.7424 | 0.7545 |
| $10 B | IC | 0.0272 | 0.0267 | 0.0264 |
| | TC | 0.5880 | 0.6690 | 0.6955 |
| $20 B | IC | 0.0263 | 0.0239 | 0.0224 |
| | TC | 0.6008 | 0.6603 | 0.6813 |
| $30 B | IC | 0.0270 | 0.0249 | 0.0232 |
| | TC | 0.6064 | 0.6805 | 0.6951 |

Notably, the dynamics of both IC and TC across different turnover levels agree with our prediction: TC is rising with increased turnover (less constraints on the portfolio weights) and net IC is falling (more drag on portfolio performance due to turnover costs). Predictably, net IC is always smaller than average “raw” IC, which is assumed to be equal to 0.05. Without computing the volatility of the portfolio for each AUM-turnover level (from Eq. (4)), cannot be matched empirically the observed portfolio returns with the predicted ones, but the overall trend is in line with our expectations.

Thus, a number of embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A method for optimizing return of an investment fund, based on a relation between assets under management (AUM), fund strategy and turnover, the method comprising:
(a) generating a turnover efficient frontier for an investment fund that models fund return versus fund turnover for one or more fund sizes from computer simulations based on the characteristics of the fund and historical trading data;
(b) determining a current fund return and a current fund turnover of the fund;
(c) determined a current position of the fund on said turnover efficient frontier based on the current fund return and fund turnover;
(d) determining whether an increase or a decrease in one of fund size or turnover will move the fund to an optimal point on said turnover efficient frontier; and
(e) storing the results of step (d).

2. The method as recited by claim 1, further comprising a step of displaying at least a portion of the generated turnover efficient frontier and the current position on a display device.

3. The method as recited by claim 1, further comprising a step of generating a report graphically illustrating at least a portion of the generated turnover efficient frontier and the current position on a display device.

4. The method as recited by claim 1, further comprising steps of:
receiving data indicative of a historical performance of assets in said investment fund;
wherein, steps (a) and (b) are based upon said received data indicative of a historical performance.

5. The method as recited by claim 1, further comprising steps of:
calculating an optimal amount of investment and turnover for said investment fund based on said turnover efficient frontier.

6. The method as recited by claim 1, wherein said turnover efficient frontier comprises a set of curves indicating net return for said investment fund at different assets under management volumes for varying turnover rates.

7. The method as recited by claim 1, further comprising steps of:
identifying optimal points along said turnover efficient frontier curves that maximize return; and
generating a portfolio rebalancing strategy recommendation for said investment fund based on said turnover efficient frontier, accounting for said external limitations on said investment fund, said recommendation including a recommendation to either increase or decrease turnover of said investment fund or to expand or reduce assets under management in said investment fund.

8. A system for optimizing return of an investment fund, based on a correlation between assets under management (AUM) and turnover, the system comprising:
means for generating a turnover efficient frontier for an investment fund that models fund return versus fund turnover for one or more fund sizes from computer simulations based on the characteristics of the fund and historical trading data;
means for determining a current fund return and fund turnover of the investment fund;
means for determining a current position of the fund on said turnover efficient frontier based on the current fund return and fund turnover;
means for determining whether an increase or a decrease in one of fund size or turnover will move the fund to an optimal point on said turnover efficient frontier; and
means for storing the results of said determination of whether to increase or decrease in one of fund size and turnover.

9. The system as recited by claim 8, further comprising means for displaying at least a portion of the generated turnover efficient frontier and the current position on a display device.

10. The system as recited by claim 8, further comprising means for generating a report graphically illustrating at least a portion of the generated turnover efficient frontier and the current position on a display device.

11. The system as recited by claim 8, further comprising means for receiving data indicative of a historical performance of assets in said investment fund.

12. The system as recited by claim 8, further comprising means for calculating an optimal amount of investment and turnover for said investment fund based on said turnover efficient frontier.

13. The system as recited by claim 8, wherein said turnover efficient frontier comprises a set of curves indicating net return for said investment fund at different assets under management volumes for varying turnover rates.

14. The system as recited by claim 8, further comprising:
means for identifying optimal points along said turnover efficient frontier curves that maximize return; and
means for generating a portfolio rebalancing strategy recommendation for said investment fund based on said turnover efficient frontier, accounting for said external limitations on said investment fund, said recommendation including a recommendation to either increase or decrease turnover of said investment fund or to expand or reduce assets under management in said investment fund.

15. A computer program product comprising a computer readable medium having stored thereon executable computer instructions for optimizing return of an investment fund, based on a relation between assets under management (AUM), fund strategy and turnover, by performing operations comprising the following steps:
(f) generating a turnover efficient frontier for an investment fund that models fund return versus fund turnover for one or more fund sizes from computer simulations based on the characteristics of the fund and historical trading data;
(g) determining a current fund return and fund turnover of the fund;
(h) determined a current position of the fund on said turnover efficient frontier based on the current fund return and fund turnover;
(i) determining whether an increase or a decrease in one of fund size or turnover will move the fund to an optimal point on said turnover efficient frontier; and
(j) storing the results of step (d).

16. The computer program product as recited by claim 15, further comprising an instruction for displaying at least a portion of the generated turnover efficient frontier and the current position on a display device.

17. The computer program product as recited by claim 15, further comprising an instruction for generating a report graphically illustrating at least a portion of the generated turnover efficient frontier and the current position on a display device.

18. The computer program product as recited by claim 15, further comprising instructions for:
receiving data indicative of a historical performance of assets in said investment fund;
wherein, steps (a) and (b) are based upon said received data indicative of a historical performance.

19. The computer program product as recited by claim 15, further instructions for:
calculating an optimal amount of investment and turnover for said investment fund based on said turnover efficient frontier.

20. The computer program product as recited by claim 15, wherein said turnover efficient frontier comprises a set of curves indicating net return for said investment fund at different assets under management volumes for varying turnover rates.

21. The computer program product as recited by claim 15, further comprising instructions for:
identifying optimal points along said turnover efficient frontier curves that maximize return; and
generating a portfolio rebalancing strategy recommendation for said investment fund based on said turnover efficient frontier, accounting for said external limitations on said investment fund, said recommendation including a recommendation to either increase or decrease turnover of said investment fund or to expand or reduce assets under management in said investment fund.

22. A system for optimizing return of an investment fund, based on a correlation between assets under management (AUM) and turnover, the system comprising:
a server facility coupled with an electronic data network and configured to generate a turnover efficient frontier for an investment fund that models fund return versus fund turnover for one or more fund sizes from computer simulations based on the characteristics of the fund and historical trading data, to determine a current fund return and fund turnover of the investment fund, to determine a current position of the fund on said turnover efficient frontier based on the current fund return and fund turnover, to determine whether an increase or a decrease in one of fund size or turnover will move the fund to an optimal point on said turnover efficient frontier, and to store the results of said determination of whether to increase or decrease in data storage facilities.

23. The system as recited by claim 22, wherein said server facility is further configured to transmit data for a portion of the generated turnover efficient frontier and the current position on a display device to be displayed on a display device.

24. The system as recited by claim 22, wherein said server facility is further configured to generate a report graphically illustrating at least a portion of the generated turnover efficient frontier and the current position onto a display device.

25. The system as recited by claim 22, wherein said server facility is further configured to receive data indicative of a historical performance of assets in said investment fund.

26. The system as recited by claim 22, wherein said server facility is further configured to calculate an optimal amount of investment and turnover for said investment fund based on said turnover efficient frontier.

27. The system as recited by claim 22, wherein said turnover efficient frontier comprises a set of curves indicating net return for said investment fund at different assets under management volumes for varying turnover rates.

28. The system as recited by claim 22, wherein said server facility is further configured to identify optimal points along said turnover efficient frontier curves that maximize return, and to generate a portfolio rebalancing strategy recommendation for said investment fund based on said turnover efficient frontier, accounting for said external limitations on said investment fund, said recommendation including a recommendation to either increase or decrease turnover of said investment fund or to expand or reduce assets under management in said investment fund.

29. The system as recited by claim 22, further comprising:
data storage facilities for storing portfolio and turnover efficient frontier data; and
a client user interface executable on a computer or within a web browser, said client user interface configured to communicate with said server facility to exchange data, said client user interface configured to receive input data and to communicate said input data to said server facility, said client user interface configured to receive turnover efficient frontier data from said server facilities and to display said turnover efficient frontier.
